(19) United States
(12) Patent Application Publication
(10) Pub. No.: US 2005/0221134 A1
(43) Pub. Date: Oct. 6, 2005

(54) Method and apparatus for operating a fuel cell

(76) Inventors: Wen K. Liu, Newark, DE (US); Simon J. Cleghorn, Newark, DE (US); William B. Johnson, Newark, DE (US)

Correspondence Address: GORE ENTERPRISE HOLDINGS, INC., 551 PAPER MILL ROAD, P. O. BOX 9206, NEWARK, DE, 19714-9206, US

(21) Appl. No.: 10/819,091

(22) Filed: Apr. 6, 2004

(51) Int. Cl. H01M 8/04; H01M 8/10

(52) U.S. Cl. 429/13; 429/24; 429/30; 429/22

(57) ABSTRACT

A method of operating a fuel cell at an operating temperature below about 150 degrees Celsius, wherein the fuel cell has an anode and a cathode with an electrolyte interposed therebetween, the cathode having at least one surface in contact with a cathode chamber having a gas inlet and a gas outlet, and the anode in contact with an anode chamber having a gas inlet and a gas outlet, and the electrolyte containing less than about 500 ppm of a catalyst capable of enhancing the formation of radicals from hydrogen peroxide. The method includes the steps of applying a fuel to the anode chamber; applying an oxidant to the cathode chamber; and controlling the amount of water supplied to the anode chamber and the cathode chamber such that water vapor pressure is sub-saturated at the operating temperature at the gas outlet of the cathode chamber. Also disclosed is an apparatus comprising sensors to measure outlet relative humidity of the gas outlets of a fuel cell and a means to control the relative humidity on the gas inlets of a fuel cell, such that the apparatus can control the relative humidity of the gas inlets to maintain an average relative humidity in the fuel cell of less than 100%.

### FIELD OF THE INVENTION

The present invention relates to a method of operating a fuel cell or cells to improve their durability and life, and to an apparatus for doing so.

### BACKGROUND OF THE INVENTION

Fuel cells are devices that convert fluid streams containing a fuel, for example hydrogen, and an oxidizing species, for example, oxygen or air, to electricity, heat and reaction products. Such devices comprise an anode, where the fuel is provided; a cathode, where the oxidizing species is provided; and an electrolyte separating the two. The fuel and/or oxidant typically is a liquid or gaseous material. The electrolyte is an electronic insulator that separates the fuel and oxidant. It provides an ionic pathway for the ions to move between the anode, where the ions are produced by reaction of the fuel, to the cathode, where they are used to produce the product. The electrons produced during formation of the ions are used in an external circuit, thus producing electricity. As used herein, fuel cells may include a single cell comprising only one anode, one cathode and an electrolyte interposed therebetween, or multiple cells assembled in a stack. In the latter case there are multiple separate anode and cathode areas wherein each anode and cathode area is separated by an electrolyte. The individual anode and cathode areas in such a stack are each fed fuel and oxidant, respectively, and may be connected in any combination of series or parallel external connections to provide power. Additional components in a single cell or in a fuel cell stack may optionally include means to distribute the reactants across the anode and cathode, including, but not limited to porous gas diffusion media and/or so-called bipolar plates, which are plates with channels to distribute the reactant. Additionally, there may optionally be means to remove heat from the cell, for example by means of separate channels in which a cooling fluid can flow.

A Polymer Electrolyte Membrane Fuel Cell (PEMFC) is a type of fuel cell where the electrolyte is a polymer electrolyte. Other types of fuel cells include Solid Oxide Fuel Cells (SOFC), Molten Carbonate Fuel Cells (MCFC), Phosphoric Acid Fuel Cells (PAFC), etc. As with any electrochemical device that operates using fluid reactants, unique challenges exist for achieving both high performance and long operating times. In order to achieve high performance it is necessary to reduce the electrical and ionic resistance of components within the device. Recent advances in the polymer electrolyte membranes have enabled significant improvements in the power density of PEMFCs. Steady progress has been made in various other aspects including lowering Pt loading, extending membrane life, and achieving high performance at different operating conditions. However, many technical challenges are still ahead. One of them is for the membrane electrode assembly (MEA) to meet the lifetime requirements for various potential applications. These range from hundreds of hours for portable applications to 5,000 hours or longer for automotive applications to 40,000 hours or longer in stationary applications. In all cases, the membrane must not fail, and there must not be severe electrode degradation.

As is well known in the art, decreasing the thickness of the polymer electrolyte membrane can reduce the membrane ionic resistance, thus increasing fuel cell power density. Within this application power density is defined as the product of the voltage and current in the external circuit divided by the geometric area of the active area in the cathode. The active area is the area in which the catalyst is present in the cathode electrode.

However, reducing the membranes physical thickness can increase the susceptibility to damage from other device components leading to shorter cell lifetimes. Various improvements have been developed to mitigate this problem. For example, U.S. Pat. No. RE 37,307 to Bahar et al., incorporated herein in its entirety by reference, shows that a polymer electrolyte membrane reinforced with a fully impregnated microporous membrane has advantageous mechanical properties. Although this approach is successful in improving cell performance and increasing lifetimes, even longer life would be even more desirable.

During normal operation of a fuel cell or stack the power density typically decreases as the operation time goes up. This decrease, described by various practitioners as voltage decay, fuel cell durability, or fuel cell stability, is not desirable because less useful work is obtained as the cell ages during use. Ultimately, the cell or stack will eventually produce so little power that it is no longer useful at all. In this application, durability is defined as the ability of a fuel cell with a specific set of materials to maintain its power output at an acceptable level when operating under a given set of operating conditions. It is quantified herein by determining the voltage decay rate during a life test of a fuel cell. A life test is generally performed under a given set of operating conditions for a fixed period of time. The test is performed under a known temperature, relative humidity, flow rate and pressure of inlet gases, and is done either in fixing the current or the voltage. In this application, the life tests are performed under constant current conditions, though it is well known in the art that constant voltage life tests will also produce decay in the power output of a cell. Herein, the decay rate is calculated by temporarily stopping a life test, i.e., removing the cell from external load. After the cell has come to open-circuit conditions, a polarization curve is taken under the same operating conditions, e.g., cell temperature and relative humidity, as the life test. This procedure may be performed many times during a life-test. The voltage at a given current, for example 800 mA, and time is determined from the polarization curve at that time. The decay rate at any given time of interest is then calculated from the slope of a linear fit of a plot of the voltages recorded at all the tested times up to the time of interest versus time.

Another critical variable in the operation of fuel cells is the temperature at which the cell is operated. Although this varies by the type of system, for PEMFCs, the operating temperature is less than about 150 degrees Celsius. PEMFCs are more typically operated between 40 and 80 degrees Celsius because in that temperature range the power output is acceptably high, and the voltage decay with time is acceptably low. At higher temperature, decay rates tend to increase, and cell durability thereby decreases. It would be highly desirable to operate at higher temperatures, for example between about 90 and 150 degrees Celsius, though. By so doing the effects of potential poisons, for example carbon monoxide, would be reduced. Furthermore, above 100 degrees Celsius at ambient pressure, liquid water, which can cause flooding and other deleterious effects, will not be present. Yet, with current materials and operating conditions lifetimes are unacceptably short at these higher temperatures.

Although there have been many improvements to fuel cells in an effort to improve life of fuel cells, most have focused on using improved materials. Very few have focused on specific operational methods or apparata that would act to maximize lifetimes or durability of a fuel cell.

### SUMMARY OF THE INVENTION

The instant invention is a method of operating a fuel cell at an operating temperature below about 150 degrees Celsius, said fuel cell having an anode and a cathode with an electrolyte interposed therebetween, said cathode having at least one surface in contact with a cathode chamber having a gas inlet and a gas outlet, and said anode in contact with an anode chamber, and said electrolyte containing less than about 500 ppm of a catalyst capable of enhancing the formation of radicals from hydrogen peroxide. The method comprises the steps of applying a fuel to said anode chamber; applying an oxidant to said cathode chamber; and controlling the amount of water supplied to said anode chamber and said cathode chamber such that water vapor pressure is sub-saturated at said operating temperature at the gas outlet of the cathode chamber. In this application sub-saturated water vapor means that the vapor pressure of the water is below the equilibrium vapor pressure for water at said operating temperature. Sub-saturated water vapor pressure is also interchangeably described herein as a relative humidity of less than 100%.

Another embodiment of the invention is a method of operating a fuel cell at an operating temperature below about 150 degrees Celsius, said fuel cell having an anode and a cathode with an electrolyte interposed therebetween, said anode having at least one surface in contact with an anode chamber having a gas inlet and a gas outlet, said cathode in contact with a cathode chamber, and said electrolyte containing less than about 500 ppm of a catalyst capable of enhancing the formation of radicals from hydrogen peroxide. The method comprises the steps of applying a fuel to said anode chamber; applying an oxidant to said cathode chamber; and controlling the amount of water supplied to said anode chamber and said cathode chamber such that water vapor pressure is sub-saturated at said operating temperature at the gas outlet of the anode chamber.

In a further embodiment, the method comprises the steps of applying a fuel to said anode chamber; applying an oxidant to said cathode chamber; said electrolyte containing less than about 500 ppm of a catalyst capable of enhancing the formation of radicals from hydrogen peroxide and controlling the amount of water supplied to said anode chamber and said cathode chamber such that the average water vapor pressure in said fuel cell is sub-saturated at said operating temperature. The average water vapor pressure in the cell is defined mathematically below.

Another embodiment of the invention is any of the methods described above wherein the fuel cell is a polymer electrolyte membrane fuel cell having an anode, a cathode, and an electrolyte interposed therebetween, wherein said electrolyte comprises a polymer. A further embodiment of these methods include methods wherein the amount of water supplied to said anode chamber and said cathode chamber is such that the water vapor is sub-saturated at the anode inlet, and optionally, at the cathode inlet.

Yet more embodiments of the invention include any of the methods described above wherein the polymer of a polymer electrolyte fuel cell comprises a polymer containing ionic acid functional groups attached to the polymer backbone, wherein said ionic acid functional groups are selected from the group of sulfonic, sulfonimide and phosphonic acids; and optionally further comprises a fluoropolymer. Said polymer may be selected from the group containing perfluorosulfonic acid polymers, polystyrene sulfonic acid polymers; sulfonated Poly(aryl ether ketones); and polymers comprising phthalazinone and a phenol group, and at least one sulfonated aromatic compound. The polymer may also comprise an expanded polytetrafluoroethylene membrane having a porous microstructure of polymeric fibrils and optionally nodes; an ion exchange material impregnated throughout the membrane, wherein the ion exchange material substantially impregnates the membrane to render an interior volume of the membrane substantially occlusive.

In further embodiments of the invention the fuel used in the methods comprises hydrogen and the oxidant comprises oxygen.

Yet additional embodiments of the invention include any of the methods above wherein said catalyst capable of enhancing the formation of radicals from hydrogen peroxide is present in the membrane at a concentration of less than about 150 ppm, or less than about 20 ppm.

The instant invention includes the methods described above when operating between 40 and 150 degrees Celsius, including but not limited to 130 degrees, 110 degrees, 95 degrees and 80 degrees.

Further embodiments of the invention include an apparatus comprising sensors to measure the outlet relative humidity of the gas outlets of a fuel cell and a means to control the relative humidity on the gas inlets of a fuel cell, such that said apparatus can control the relative humidity of the gas inlets to maintain sub-saturated conditions of the fuel cell on the anode outlet or the cathode outlet.

One further embodiment is an apparatus comprising sensors to measure outlet relative humidity of the gas outlets of a fuel cell and a means to control the relative humidity on the gas inlets of a fuel cell, such that said apparatus can control the relative humidity of the gas inlets to maintain an average relative humidity in the fuel cell of less than 100%.

### DESCRIPTION OF THE DRAWINGS

The operation of the present invention should become apparent from the following description when considered in conjunction with the accompanying figure.

FIG. 1 is a schematic of the cross section of a single fuel cell.

FIG. 2 is a schematic of an apparatus capable of operating a fuel cell so that it has high durability and long life.

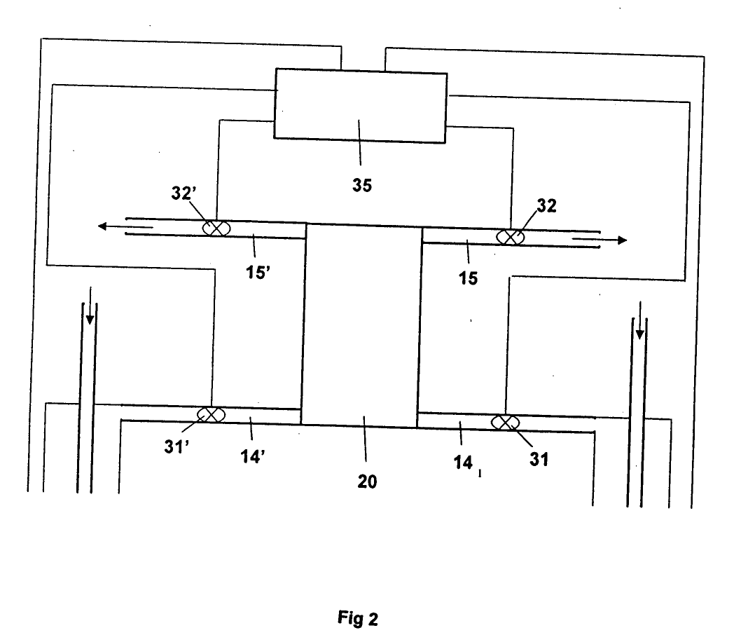

### DETAILED DESCRIPTION OF THE INVENTION

In order to develop membranes that have a long-life in a fuel cell, the mechanisms of failure need to be understood. Without being held to any particular theory, it is known in the art that there are two major forms of membrane failure, chemical and mechanical. The latter has been addressed by various approaches, for example by the formation of composite membranes described by Bahar et. al. in RE 37,707. Approaches to address the former have also been proposed, for example in GB 1,210,794 assigned to E. I. Du Pont de Nemours, Inc., where a chemical process to stabilize ionomers was described. In '794 it is proposed that radicals produced during fuel cell operation attack the polymer membrane and degrade it (pg. 3, line 38-51). Furthermore, it was demonstrated that such attack can be accelerated by promoting the formation of radicals using a catalyst, e.g., iron cations, as shown during an ex-situ test in a hydrogen peroxide solution (pg. 4, line 63-86 in '794). Later work has shown that there are a number of transition metal complexes that can act in the same fashion. Generally, transition metals and/or transition metal oxides that have two redox states have been found to be effective catalysis for this reaction. Such catalysts capable of enhancing the formation of radicals from hydrogen peroxide can include, but are not limited to, metal and metal oxide ions, including cations of Ti, VO, Cr, Mn, Fe, Co, Cu, Ag, Eu and Ce. [see for example, Table 9, pg. 123 in Stukul, Giorgio, in chapter 6, “Nucleophilic and Electrophilic Catalysis with Transition Metal Complexes” of Catalytic Oxidations with Hydrogen Peroxide as Oxidant, Stukul, Giorgio (ed.), Kluwer Academic Press, Dordrecht, Netherlands, 1992]. Thus, it is well known in the art that a necessary, though not necessarily sufficient condition, to produce chemical degradation of membranes in fuel cells is to reduce or eliminate the concentration of catalysts that are capable of the formation of radicals from hydrogen peroxide. Yet even with low concentrations of such catalysts, degradation can still reach unacceptably high rates. Inventors have discovered that by operating under a specific set of operating conditions described more fully below, there is a surprisingly significant reduction of membrane degradation, and a concomitant increase in membrane life, even at relatively high temperatures.

The conventional wisdom in the fuel cell industry is that operation of a fuel cell in non sub-saturated conditions is advantageous to improving the membrane life in a fuel cell [see for example, FIG. 5, and associated text in Knights, Shanna D.; Colbow, Kevin M.; St Pierre, Jean; Wilkinson, David P.; Journal of Power Source, 127(1-2), 127-134(2004); or page 650 of LaConti A. B., Hamdan, M., McDonald, R. C., chapter 49, volume 3, pgs. 647-662 of Handbook of Fuel Cells—Fundamentals, Technology, Applications, Vielstich, W., Lamm, A., Gerischer, H. (eds), John Wiley & Sons, 2003]. We have discovered that by using sub-saturated conditions in the method described more fully below, it is possible to have very long membrane life, even at relatively high temperatures. Because the membrane is usually one of the first components in a fuel cell to fail, a long membrane life is critical in designing a fuel cell with long life. Failure of the membrane can be the presence of a hole or other defect that allows significant gas to cross over through the membrane at the test temperature. More specifically, membrane failure as used herein is defined as follows: when a 2 psig pressure of hydrogen applied to the anode outlet produces a flow rate of 2.5 cm³/min or greater of hydrogen at the cathode outlet when the cathode is held at ambient pressure in nitrogen and the cell is at the operating temperature of the test. In electrochemical terms, a flow of 2.5 cm³/min is equivalent in to about 15 mA/cm² gas cross-over with the cell hardware used herein. Such tests are normally done in-situ as described more fully below in the Membrane Integrity test section.

The instant invention is both a method for operating a fuel cell and an apparatus specifically designed to control a fuel cell so that it operates by such a method. Applicants have discovered that by operating a fuel cell using the inventive methods outlined herein, that the lifetime of the membrane in the cell is increased, the voltage decay of the fuel cell during operation is decreased, and the chemical degradation of the membrane is decreased. The inventive method is a method of operating a fuel cell at an operating temperature below about 150 degrees Celsius, said fuel cell having an anode and a cathode with an electrolyte interposed therebetween, said cathode having at least one surface in contact with a cathode chamber having a gas inlet and a gas outlet, said anode in contact with an anode chamber, and said electrolyte containing less than about 500 ppm of a catalyst capable of enhancing the formation of radicals from hydrogen peroxide. One embodiment of the method comprises the steps of applying a fuel to said anode chamber; applying an oxidant to said cathode chamber; and controlling the amount of water supplied to said anode chamber and said cathode chamber such that water vapor pressure is sub-saturated at said operating temperature at the gas outlet of the cathode chamber. Thus, we have discovered that when operating a fuel cell with a concentration of a catalyst capable of enhancing the formation of radicals from hydrogen peroxide of less than about 500 ppm, lower membrane degradation, longer membrane life, and lower decay rates can be obtained when operating at sub-saturated outlet conditions at the gas outlet of the cathode.

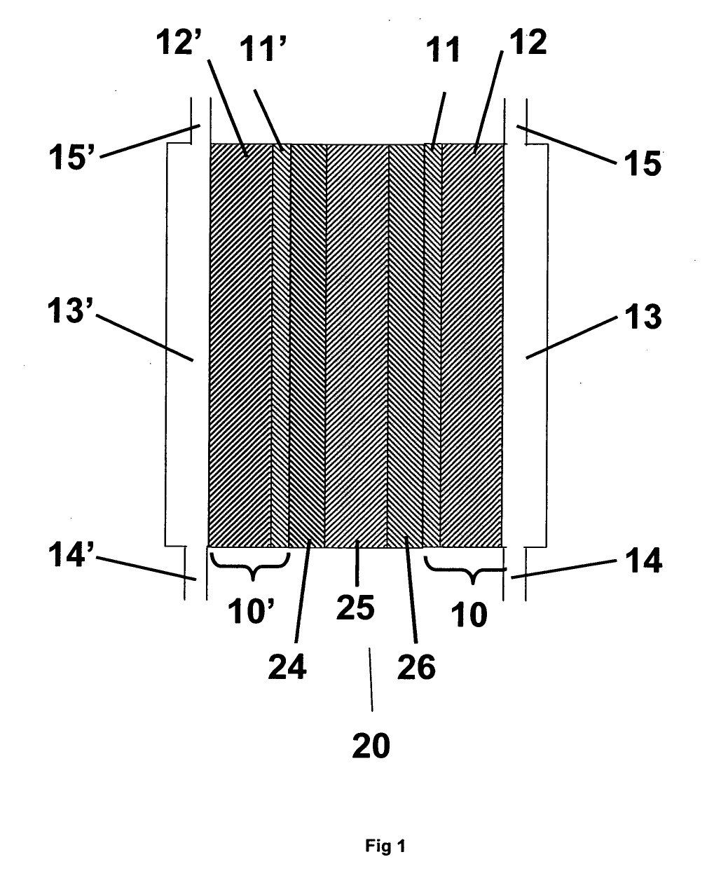

The fuel cell of the method can be of any type, for example molten carbonate, phosphoric acid, solid oxide or most preferably, a polymer electrolyte membrane (PEM) fuel cell. As shown in FIG. 1, such PEM fuel cells 20 comprise an anode 24 a cathode 26 and a polymer electrolyte 25 sandwiched between them. A PEM fuel cell may optionally also include gas diffusion layers 10′ and 10 on the anode and cathode sides, respectively. These GDM function to more efficiently disperse the fuel and oxidant. In FIG. 1 the fuel flows through the anode chamber 13′, entering through an anode gas inlet 14′ and exiting through an anode gas outlet 15′. Correspondingly, the oxidant flows through the cathode chamber 13, entering through a cathode gas inlet 14 and exiting through a cathode gas outlet 15. The cathode and anode chambers may optionally comprise plates (not shown in FIG. 1) containing grooves or other means to more efficiently distribute the gases in the chambers. The gas diffusion layers 10 and 10′ may optionally comprise a macroporous diffusion layer 12 and 12′, as well as a microporous diffusion layer 11 and 11′.

Microporous diffusion layers known in the art include coatings comprising carbon and optionally PTFE, as well as free standing microporous layers comprising carbon and ePTFE, for example CARBEL® MP gas diffusion media available from W. L. Gore & Associates. In this application the cathode is considered to have at least one surface in contact with the cathode chamber if any portion of said cathode has access to the fluid used as oxidant. Correspondingly, the anode is considered to have at least one surface in contact with the anode chamber if any portion of said anode has access to the fluid used as fuel. The fluids used as fuel and oxidant may comprise either a gas or liquid. Gaseous fuel and oxidant are preferable, and a particularly preferable fuel comprises hydrogen. A particularly preferable oxidant comprises oxygen.

The anode and cathode electrodes comprise appropriate catalysts that promote the oxidation of fuel (e.g., hydrogen) and the reduction of the oxidant (e.g., oxygen or air), respectively. For example, for PEM fuel cells, anode and cathode catalysts may include, but are not limited to, pure noble metals, for example Pt, Pd or Au; as well as binary, ternary or more complex alloys comprising said noble metals and one or more transition metals selected from the group Ti, V, Cr, Mn, Fe, Co, Ni, Cu, Zn, Y, Zr, Nb, Mo, Ru, Rh, Ag, Cd, In, Sn, Sb, La, Hf, Ta, W, Re, Os, Ir, Tl, Pb and Bi. Pure Pt is particularly preferred for the anode when using pure hydrogen as the fuel. Pt—Ru alloys are preferred catalysts when using reformed gases as the fuel. Pure Pt is a preferred catalyst for the cathode in PEMFCs. Non-noble metal alloys catalysts are also used, particularly in non-PEMFCs, and as the temperature of operation increases. The anode and cathode may also, optionally, include additional components that enhance the fuel cell operation. These include, but are not limited to, an electronic conductor, for example carbon, and an ionic conductor, for example a perfluorosulfonic acid based polymer or other appropriate ion exchange resin. Additionally, the electrodes are typically porous as well, to allow gas access to the catalyst present in the structure.

The electrolyte 25 of the PEM fuel cell may be any ion exchange membrane known in the art. These include but are not limited to membranes comprising phenol sulfonic acid; polystyrene sulfonic acid; fluorinated-styrene sulfonic acid; perfluorinated sulfonic acid; sulfonated Poly(aryl ether ketones); polymers comprising phthalazinone and a phenol group, and at least one sulfonated aromatic compound; aromatic ethers, imides, aromatic imides, hydrocarbon, or perfluorinated polymers in which ionic an acid functional group or groups is attached to the polymer backbone. Such ionic acid functional groups may include, but is not limited to, sulfonic, sulfonimide or phosphonic acid groups. Additionally, the electrolyte 25 may further optionally comprise a reinforcement to form a composite membrane. Preferably, the reinforcement is a polymeric material. The polymer is preferably a microporous membrane having a porous microstructure of polymeric fibrils, and optionally nodes. Such polymer is preferably expanded polytetrafluoroethylene, but may alternatively comprise a polyolefin, including but not limited to polyethylene and polypropylene. An ion exchange material is impregnated throughout the membrane, wherein the ion exchange material substantially impregnates the microporous membrane to render an interior volume of the membrane substantially occlusive, substantially as described in Bahar et al, RE37,307, thereby forming the composite membrane.

Additional methods of decreasing membrane degradation and increasing membrane life have also been discovered. Another embodiment of the invention is a method of operating a fuel cell at an operating temperature below about 150 degrees Celsius, said fuel cell having an anode and a cathode with an electrolyte interposed therebetween, said anode having at least one surface in contact with an anode chamber having a gas inlet and a gas outlet, said cathode in contact with a cathode chamber, and said electrolyte containing less than about 500 ppm of a catalyst capable of enhancing the formation of radicals from hydrogen peroxide. The method comprises the steps of applying a fuel to said anode chamber; applying an oxidant to said cathode chamber; and controlling the amount of water supplied to said anode chamber and said cathode chamber such that water vapor pressure is sub-saturated at said operating temperature at the gas outlet of the anode chamber. In a further embodiment, the method comprises the steps of applying a fuel to said anode chamber; applying an oxidant to said cathode chamber; and controlling the amount of water supplied to said anode chamber and said cathode chamber such that the average water vapor pressure in said fuel cell is sub-saturated at said operating temperature. As used herein the average water vapor pressure in the cell is the vapor pressure of water calculated from a mass balance on the water during fuel cell operation. In particular, it can be calculated from multiplying the total pressure in the fuel cell by the mole fraction of water in the gas stream. The mole fraction of water in the gas stream is the sum of the water supplied to the cell and that produced by the cell, divided by that sum plus the number of moles of gas at the outlets of the cell. The moles of gas at the outlets of the cell can be calculated from the gas stoichiometry and the operating current of the cell. The average water vapor pressure is interchangeably described herein as the average theoretical relative humidity, or alternatively, the average relative humidity in the fuel cell, both denoted by \overline{RH}ₜₕ. The average water vapor pressure is sub-saturated when the average relative humidity in the fuel cell is less than 100%. The mathematical expression for \overline{RH}ₜₕ is given below.

Yet another embodiment of the invention is any of the methods described above wherein the polymer of a polymer electrolyte fuel cell comprises a sulfonic acid containing polymer, including but not limited to a perfluorosulfonic acid or polystyrene sulfonic acid polymer. Said polymer may further optionally comprise a fluoropolymer, including, but not limited to expanded polytetrafloroethylene. The polymer may also comprise an expanded polytetrafluoroethylene membrane having a porous microstructure of polymeric fibrils, and optionally nodes; an ion exchange material impregnated throughout the membrane, wherein the ion exchange material substantially impregnates the membrane to render an interior volume of the membrane substantially occlusive.

The temperature of operation of the fuel cell varies depending on the type of cell, the components used, and the type of fuel. For example, PEM fuel cells typically operate at temperatures below 150 degrees Centigrade. Preferably, the temperature of operation of said PEM fuel cells is between 40 and 150 degrees Celsius, including but not limited to operation at temperatures of about 80, about 95, about 110 or about 130 degrees Celsius.

Yet another embodiment of the invention is an apparatus to control a fuel cell such that the outlet of either the anode, or the cathode, or the average relative humidity in the fuel cell is sub-saturated. Such an apparatus, shown schematically in FIG. 3, controls the operating conditions of a fuel cell 20 by measuring the relative humidity in the outlet gas streams of the anode 15′ and cathode 15 using sensors 32′ and 32. The electrical output from these sensors is fed to a computer or other electronic means capable of computing a signal that can be used to control the input relative humidity. The magnitude of this signal is adjusted dynamically in a closed loop system and applied to a means for controlling the relative humidity of the gas inlets so that the output relative humidity of either the cathode, anode, or average relative humidity in the fuel cell is sub-saturated. Such means to control the relative humidity on the gas inlets of the fuel cell may include, but is not limited to the following: means to control the total gas pressure applied to the cell, means to control the gas stoichiometry and/or flow rate of the inlet gases, means to control the cell and/or inlet gas temperatures, and means to control the relative humidity of the inlet gases. Such means to accomplish each of these means is well known in the art. By way of example, for the case of controlling the relative humidity of the inlet gases, bottles are filled with water through which the input gases are sparged. In this case, the input relative humidity can be controlled by the use of heating tape wrapped on the bottle (not shown in FIG. 3) or by other means to control the temperature of the water in the bottle. Separate bottles 33′ and 33 for the anode and the cathode are preferably used as shown to control the relative humidity of either the inlet anode gas, inlet cathode gas, or both, but a single bottle may also be used. Optionally, the relative humidity of the inlet gas streams from the anode 14′ and cathode 14 may also be measured using sensors 31′ and 31 as part of the means to control the input relative humidity.

### EXAMPLES

Description of Membrane Electrode Assemblies (MEAs) Three types of MEAs labeled Type A, Type B and Type C, were used in the testing. Type A MEAs were PRIMEA® Series 5510 Membrane Electrode Assemblies with a loading of 0.4 mg/cm² Pt on both the anode and cathode sides, available from W. L. Gore & Associates. These MEAs comprise a GORE-SELECTcomposite membrane of an ePTFE-reinforced perfluorosulfonic acid ionomer. Type B MEAs were identical to Type A except there was an additional treatment to dope the membrane prior to assembly into an MEA with Fe at a level of about 550 ppm. Iron was chosen to be representative of catalysts capable of enhancing the formation of radicals from hydrogen peroxide that can accelerate membrane degradation. Specifically, iron was added to the membranes used in the preparation of Type A MEAs by preparing a 5 PPM iron solution by fully dissolving 0.034 g ferrous sulfate heptahydrate crystals in 1350 g deionized water. A weighed membrane of about 1.3 g was placed in a 250-ml plastic wide-mouth bottle. 150-ml of the doping solution was added to the bottle to cover the sample. The bottle was capped with a vented lid and placed in a preheated bath set at 60° C. After 17.5 hours, the bottle was removed. The solution was carefully decanted and discarded. To the membrane sample remaining in the bottle, 100-ml of de-ionized water was added. The bottle was shaken briefly to wash the membrane sample. The membrane sample was removed and placed on a clean surface. The doped membrane sample was allowed to dry overnight at ambient conditions. The iron doping level was measured to be 550 ppm by chemical analysis at Galbraith Laboratories, in Knoxyille, Tenn. from a mixture of three different membrane samples prepared from the same solution batch described above. A similar analysis performed on seven different lots of membranes used in Type A MEAs showed average iron content to be 12 ppm.

Type C MEAs used a composite membrane formed of a porous expanded PTFE reinforcement with a sulfonated polystyrene-block-poly (ethylene-ran-butylene)-block-polystyrene ionomer obtained from Aldrich Chemicals (Product number 448885) as a 5 weight percent solution in 1-propanol and dichloroethane. These composite membranes were prepared generally according to the teachings of Bahar et. al., RE37,707, and specifically as follows:
1. An ePTFE membrane with mass per area of 7.0 g/m², thickness of 20 microns, and porosity of at least 85% that was prepared using the teachings of U.S. Pat. No. 3,953,566 to Gore was restrained in a 8″ diameter embroidery hoop.
2. A coat of the ionomer solution was applied on each side of membrane using a foam brush.
3. The resulting composite was dried using a hair dryer.
4. Multiple coats were applied by repeating steps 2-3 until the final thickness of the imbibed sample as measured with micrometers was 16-20 microns.
5. The composite membrane was then heat-treated for 10 minutes at 80° C. in a solvent oven.
6. The dried, annealed samples were stored at ambient conditions for approximately one week before use.

The membrane was placed between two PRIMEA® 5510 electrodes (available from Japan Gore-Tex, Inc.). This sandwich was placed between platens of a hydraulic press (PHI Inc, Model B-257H-3-MI-X20) with heated platens. The top platen was heated to 180 degrees C. A piece of 0.25″ thick GR® sheet (available from W. L. Gore & Associates, Elkton, Md.) was placed between each platen and the electrode. 15 tons of pressure was applied for 3 minutes to the system to bond the electrodes to the membrane. These MEAs were assembled into fuel cells as described below, and tested under various different operating conditions.

Cell Hardware and Assembly

For all examples, a standard 25 cm² active area hardware was used for membrane electrode assembly (MEA) performance evaluation. This hardware is henceforth referred to as “standard hardware” in the rest of this application. The standard hardware consisted of graphite blocks with triple channel serpentine flow fields on both the anode and cathode sides. The path length is 5 cm and the groove dimensions are 0.70 mm wide by 0.84 mm deep. The gas diffusion media (GDM) used was a microporous layer of Carbel® MP 30Z from W. L. Gore & Associates placed on top of a Toray TGP-H 060 macro layer, which had been wet-proofed with a 5% PTFE hydrophobic layer. Cells were assembled with 10 mil silicone gasket having a square window of 5.0 cm×5.0 cm, and a 1.0 mil polyethylene napthalate (PEN) film (available from Tekra Corp., Charlotte, N.C.) gasket hereafter referred to as the sub-gasket. The sub-gasket had an open window of 4.8×4.8 cm on both the anode and cathode sides, resulting in a MEA active area of 23.04 cm². Two different types cells were assembled. One set just used only the normal bolts to compress and seal the cell, while the other used spring-washers on the tightened bolts to better maintain a fixed load on the cell during operation. The former are referred to as bolt-loaded, while the latter are referred to as spring-loaded. The assembly procedure for the cells was as follows:
1. The 25 cm² triple serpentine channel design flow field (provided by Fuel Cell Technologies, Inc, Albuquerque, N. Mex.) was placed on a workbench.
2. For bolt-loaded cells, a 7 mil thick window-shaped CHR (Furon) cohrelastic silicone coated fabric gasket (provided by Tate Engineering Systems, Inc., Baltimore, Md.) sized so a 25 cm² GDM would fit inside it was placed on top of the flow field. For the spring-loaded cells an 11 mil thin-film polyester (mylar) carrier gasket with a 3.5 mil methyl-vinyl silicone rubber gasket (40 Shore A Durometer) bead (Freudenberg-NOK General Partnership, Plymouth, Mich.) was used instead.
3. One piece of the GDM was placed inside the gasket so that the MP-30Z layer was facing up.
4. The window-shaped sub-gasket of polyethylene napthalate (PEN) film (available from Tekra Corp., Charlotte, N.C.) sized so it slightly overlapped the GDM on all sides was placed on top of the GDM.
5. The anode/membrane/cathode system was placed on top of the sub-gasket with anode-side down.
6. Steps (b) through (e) were repeated in reverse order to form the cathode compartment. The gasket used on the cathode side was the same as that used on the anode side for the bolt-loaded cell, while a 5 mil CHR (Furon) cohrelastic silicone coated fabric gasket was used for the spring-loaded cells.
7. In the bolt-loaded case, the cell was placed in a vice and the eight retaining bolts were tightened to 45 in-lbs. In the latter, all bolts had spring washers, Belleville disc springs, purchased from MSC Industrial Supply Co. (Cat# 8777849) in place before placing the cell in a vice. The bolts were then tightened to a fixed distance that previously had been established to provide a compressive pressure of 100-120 psi in the active area. Compression pressure was measured by using Pressurex® Super Low Film pressure paper from Sensor Products, Inc.
   Fuel Cell Test Station Description

The assembled cells were tested in Fuel Cell Test Station with a Globe-Tech Gas Sub Unit 3-1-5-INJ-PT-EWM, and a Scribner load unit 890B. The humidification bottles in these stations were replaced by bottles purchased from Electrochem Corporation to improve the efficiency of the humidifiers. The humidity during testing was carefully controlled by maintaining the bottle temperatures, and by heating all inlet lines between the station and the cell to four degrees higher than the bottle temperatures to prevent any condensation in the lines. In some cases the inlet and/or outlet relative humidity of the anode and/or cathode was measured independently. Additionally, the average outlet relative humidity was calculated from a mass balance using the inlet relative humidity of the anode and cathode and the theoretical water output generated at the operating current of the cell. The procedures for both the experimental and theoretical calculations are described more fully below.

Description of Test Measurements

After cell assembly using the procedure outlined above and connecting the cell to the test station, the cell was started under test temperature and pressure as outlined below.

The cells were first conditioned at a fuel cell at a cell temperature 70 degrees C. with 70 percent relative humidity inlet gases on both the anode and cathode. The gas applied to the anode was laboratory grade hydrogen supplied at a flow rate of 1.2 times greater than what is needed to maintain the rate of hydrogen conversion in the cell as determined by the current in the cell (i.e., 1.2 times stoichiometry). Filtered, compressed and dried air was supplied to the cathode at a flow rate of two times stoichiometry.

The cells were conditioned for 18 hours. The conditioning process involved cycling the cell at 70 degrees C. between a set potential of 600 mV for 30 minutes, 300 mV for 30 minutes and 950 mV for 0.5 minutes for 18 hours. Then a polarization curve was taken by controlling the applied potential beginning at 600 mV and then stepping the potential in 50 mV increments downwards to 400 mV, then back upward to 900 mV in 50 mV increments, recording the steady state current at every step. The open circuit voltage was recorded between potentials of 600 mV and 650 mV.

After the above procedure, the cells were set to the life-test conditions. This time was considered to be the start of the life test, i.e., time equal to zero for all future decay rate measurements. The following measurement techniques were used to monitor key test variables.

Outlet and Average RH conditions

In order to understand hydration conditions that membranes were exposed to, anode and cathode outlet RH was measured at least once for each different temperature and inlet RH condition. This was accomplished by separately condensing and collecting product water from both the anode and the cathode outlets for a known amount of time. The amount of collected water was weighed, and RH was then calculated based on backpressure, stoichiometry of gases and cell temperature. The RH was calculated using the following formula

$${RH}_{i} = \frac{\frac{{n}_{{H}_{2} O}^{i} * {P}^{Tot}}{{n}_{gas} + {n}_{{H}_{2} O}^{i}} \cdot 100}{{p}_{0}^{T}} ,$$

where RHᵢ is the relative humidity of electrode chamber, i, in percent, where i is either the anode or cathode; P^{Tot} is the total gas pressure applied to the cell; nⁱ_{H}_{₂}_{O} is the measured number of moles of water from electrode i; n_{gas} is the number of excess moles of gas not used by the cell; Here n_{gas} is calculated from the stoichiometry used in gas flow and the current of operation.

Independently, the average relative humidity was theoretically calculated based upon the mass balance using the formula

$${\overline{RH}}_{th} = \frac{\frac{[ ( \sum {n}_{{H}_{2} O} ) + {n}_{prod} ] * {P}^{Tot}}{{n}_{gas} + [ ( \sum {n}_{{H}_{2} O} ) + {n}_{prod} ]} \cdot 100}{{p}_{0}^{T}}$$

where \overline{RH}ₜₕ is the average theoretical relative humidity in percent; (Σn_{H}_{₂}_{O}) is the sum of the number of moles of water provided to the cell by the inlet anode and cathode gases; n_{prod} is the number of moles of water produced during reaction in the cell; n_{gas} is the number of excess moles of gas not used in the cell; p_{Tot} is the total pressure applied to the cell, and P_{Tot} is the saturated vapor pressure of water at the operating temperature of the cell. Σn_{H}_{₂}_{O} is calculated from the gas flow rate and the anode and cathode inlet relative humidities used during the test; n_{prod} is calculated from Faraday's constant and the current of operation, and n_{gas} is calculated from the stoichiometry used in gas flow and the current of operation. At least one experimental verification of the theoretical calculation was done at each temperature used for testing. To perform this comparison, the average experimental relative humidity in the cell was calculated in the same way as \overline{RH}ₜₕ except the [(Σn_{H}_{₂}_{O})+n_{prod}] in the above equation was replaced by the sum of the number of moles of water experimentally measured in the anode and cathode outlets, n_{H}_{₂}_{O}^{anode}+n_{H}_{₂}_{O}^{cathode}. In all cases, the agreement between the average experimental RH and \overline{RH}ₜₕ was well within experimental error.
Voltage Decay Rate:

Throughout all tests, once every week (approximately every 168 hours) or more frequently if the cell voltage was dropping more quickly than expected, the constant current operating condition was interrupted and a voltage-controlled polarization curve as described above was obtained. At the end of the polarization measurement, cell voltage values at current densities of 100 and 800 mA/cm² were measured from the polarization curve. These values were plotted over time to obtain the voltage decay rate. The decay rate was recorded as the slope of a linear fit to a plot of voltage versus time for each of the two different current densities.

Ionomer Chemical Degradation Rate:

For all the tests that used Type A or Type B MEAs, the amount of fluoride ions released into the product water was monitored as a means to evaluate ionomer chemical degradation rate. This is a well-known technique to establish degradation of fuel cell materials that contain perfluorosulfonic acid membranes. Product water of fuel cell reactions was collected at the exhaust ports throughout the tests using PTFE coated stainless steel containers. The collected water was then concentrated about 20 fold (for example, 2000 ml to 100 ml) in PTFE beakers heated on hot plates. Before concentration, 1 ml of 1 M KOH was added into the beaker to prevent evaporation of HF. Fluoride concentration in the concentrated water was determined using an F⁻-specific electrode (ORION® 960900 by Orion Research, Inc.). Fluoride release rate in terms of number of F⁻/cm²-hr) was then calculated.

For tests using Type C MEAs, fluoride release rates could not be used because the membrane is hydrocarbon-based, i.e., it contains no fluorine. Therefore, in this case, the amount of acid released into the product water was monitored. In analogy to the fluoride release for perfluorosulfonic acid membranes, the number of protons released in the product water (i.e. the acidity) is indicative of the amount of degradation in the membrane. The product water was collected and concentrated the same way as in other tests except no KOH was added before concentration. Acid concentration in the concentrated water was determined by a titration with a base using an auto titrator (TitraLabg 90 by Radiometer Copenhagen). To correct for the effect of CO₂ present in air, the acid content of a distilled water sample that had been flushed with air was subtracted from the measured value. Proton release rate (number of H+/cm²-hr) was then calculated. For both proton and fluoride release rates, lower values are indicative of less chemical degradation under the given test conditions.

Membrane Integrity

The membrane integrity during testing was evaluated using an in-situ physical pinhole test. This test was carried out while the cell remained as close as possible to the actual test condition. These tests were carried out whenever there were indications that the membrane may have failed. The two primary indications for determining whether to perform the membrane integrity test were the open circuit voltage (OCV) value and the magnitude of the decay rate of the test. The OCV test was performed once per week (approximately every 168 hours) unless the voltage decay during operation seemed to indicate that the cell was not operating properly, in which case it was performed sooner. Details of OCV decay measurement were as follows:
1. The water level of anode and cathode humidification bottles was checked to make sure they were full. If not, they were refilled.
2. The cell was then taken off load while remaining at the cell temperature, gas pressure, and RH conditions at the inlets. The anode H₂ flow rate was set at 50 cc/min, and cathode flow rate was set to zero.
3. The OCV was recorded every second for 30 seconds.
4. The decay in the OCV during these measurements was examined. If this decay was significantly larger than previously observed, a physical pinhole check was initiated to measure membrane integrity.
5. If the OCV was close to that of the previous measurement, the anode and cathode flow-rates were re-set to the original values for the test.
6. The test was resumed using the original conditions.

When a physical pin-hole test was needed as described above, it was performed as follows:
1. The cell was taken off load, and set at open circuit condition while maintaining the cell temperature and RH conditions at the inlets. The gas pressure of the cell was then reduced to ambient pressure on both anode and cathode sides.
2. The gas inlet on the cathode was disconnected from its gas supply and capped tightly. The cathode outlet was then connected to a flow meter (Agilent® Optiflow 420 by Shimadzu Scientific Instruments, Inc.). The anode inlet remained connected to the H₂, supply and anode outlet remained connected to the vent.
3. The anode gas flow was increased to 800 cc/min, and the anode outlet pressure was increased to 2 psi above ambient pressure.
4. The amount of gas flow through the cathode outlet was measured using the flow meter.
5. Determination of whether the membrane had failed or not was made from the magnitude of the measured flow on the flow meter. The criteria for failure was established as the leak rate when the H₂ cross-over rate was higher than 2.5 cc/min (which is equivalent to 15 mA/cm cross over current density in a cell with active area of 23.04 cm².)

### Comparative Examples C1-C6

Cells were assembled and tested as described above using the conditions shown in Table 1. Tests C1-C4 and C6 were tested in conditions where the average outlet relative humidity is non sub-saturated. Type B membranes having high iron content were tested as Comparative examples with both non sub-saturated and saturated conditions, C3-C4 and C5, respectively. As is expected from what is well known in the art, degradation is high for these materials for all conditions tested. Results for these tests are shown in Table 2, where lifetimes, fluoride or proton release rates, and average decay rate of these comparative examples can be compared to Examples 1-10.

### Examples 1-10

Cells were assembled and tested using the conditions shown in Table 1, where the average outlet relative humidity was sub-saturated. Temperatures were varied as shown between 80 and 130 degrees C. and the anode and cathode inlet RH together with the pressure was varied to assure that the outlet conditions were sub-saturated. In some cases, the stoichiometry of the anode gas, hydrogen, was adjusted as shown in Table 1 to maintain stable cell performance. Tests were performed using the three different types of MEAs and either bolt-loaded or spring-loaded cells as shown in Table 1. Results for these tests are shown in Table 2. At a given temperature, lifetimes are greater, average decay rate at two different currents are lower, and fluoride release rates are lower at the inventive conditions when compared to the Comparative Examples (Table 2, Examples 2-5 versus C1-C2). Extended lifetimes, low decay rates and reduced fluoride or proton release rates have been surprisingly observed at all temperatures for the inventive conditions. The same result was obtained for hydrocarbon based membrane MEAs (Type C, see Table 2, Example 6 versus C6). Particularly surprising is the fact that Type C hydrocarbon membrane materials, which are known to those skilled in the art to be less stable than perfluorosulfonic acid based membranes, had longer lifetimes in the inventive conditions than the Type A membrane materials in non sub-saturated conditions at the same temperature (Table 2, Example 6 versus Examples C1-C2).

To further confirm the improvement resulted from the sub-saturated outlet conditions, the test conditions in Example 3 was switched from sub-saturated conditions after 2300 hours of testing to the non sub-saturated conditions of example C₁. After the change to non sub-saturated conditions, the fluoride release rate increased by more than an order of magnitude to 7.3E+15 F⁻ ions/hr-cm² from 3.7E+14 F⁻ ions/hr-cm², the decay rate at 100 and 800 mA/cm² increased to 70 and 600 μV/h, respectively, (from 2 and 5 μV/h, respectively), and the cell failed after only 840 hours at this condition.

TABLE 1
Test Parameters for Examples and Comparative Examples.

| | | | Inlet RH | | | |
|---|---|---|---|---|---|---|
| | | Cell | (anode/ | Pres- | Anode | |
| | MEA | Temp | cathode, | sure | gas | |
| Ex | Type | (° C.) | %) | (kPa) | stoichiometry^{‡} | Cell Build |
| 1 | A | 80 | 50/0 | 150 | 1.2 | Spring loaded |
| 2 | A | 95 | 50/0 | 270 | 1.2 | Spring loaded |
| 3* | A | 95 | 50/0* | 270 | 1.2 | Spring loaded |
| 4 | A | 95 | 50/0 | 270 | 1.2 | Bolt-loaded |
| 5 | A | 95 | 50/0 | 270 | 1.2 | Bolt-loaded |
| 6 | C | 95 | 50/3 | 270 | 2.0 | Spring loaded |
| 7 | A | 110 | 50/0 | 270 | 1.2 | Spring loaded |
| 8 | A | 130 | 50/0 | 270 | 1.2 | Spring loaded |
| 9 | C | 130 | 50/50 | 270 | 1.2 | Spring loaded |
| 10 | C | 130 | 50/50 | 270 | 1.2 | Spring loaded |
| C1 | A | 95 | 50/50 | 270 | 1.2 | Spring loaded |
| C2 | A | 95 | 50/50 | 270 | 1.2 | Spring loaded |
| C3 | B | 95 | 50/50 | 270 | 1.2 | Spring loaded |
| C4 | B | 95 | 50/50 | 270 | 1.2 | Spring loaded |
| C5 | B | 95 | 50/0 | 270 | 1.2 | Spring loaded |
| C6 | C | 95 | 50/50 | 270 | 1.2 | Spring loaded |

*Example 3 was first operated at sub-saturated outlet conditions (50/0% inlet RH) for 2,300 hours, and then switched to a non sub-saturated condition (50/50% inlet RH) until membrane failure.
^{‡}The cathode stoichiometry was fixed at 2.1 for all tests.

TABLE 2
Outlet RH values for various tests.

| | Exp. Outlet | | | | Avg Ionomer | Average Voltage | |
|---|---|---|---|---|---|---|---|
| | RH (%) | | | | Degrada-tion | Decay Rate^{[2]} | |
| | (anode/ | | Condition | Membrane | Rate^{[1]} | (μV/hr) | |
| | cathode/ | | (SS = Sub- | Life** | (# of F⁻or H⁺) | At 100 | At 800 |
| Ex. | average) | \overline{RH}ₜₕ | Saturated) | (hours) | per hr · cm²)# | mA/cm²# | mA/cm²# |
| 1 | 91/66/67 | 69 | SS | >1,500 | 6.0E+14 | 20 | 40 |
| 2 | 44/64/64 | 69 | SS | >4,000 | 6.2E+14 | 2 | 7 |
| 3* | —/—/— | 69 | SS | >2,300 | 3.7E+14 | 2 | 5 |
| 4 | —/—/— | 69 | SS | >1,540 | 1.5E+14 | 20 | 70 |
| 5 | —/—/— | 69 | SS | >1,680 | 2.8E+14 | 30 | 70 |
| 6 | 52/77/73 | 71 | SS | >1,000 | 5.5E+14 | 2 | 2 |
| 7 | 18/47/46 | 46 | SS | >2,200 | 1.2E+15 | 10 | 40 |
| 8 | 32/35/35 | 29 | SS | 52 | 6.0E+16 | N/A | N/A |
| 9 | 59/64/64 | 69 | SS | >160^{‡} | 4.0E+15 | N/A | N/A |
| 10 | —/—/— | 69 | SS | >190^{‡} | 3.2E+15 | N/A | N/A |
| C1 | 133/103/104 | 104 | Non SS. | 690 | 2.2E+15 | 100 | 300 |
| C2 | —/—/— | 104 | Non SS. | 380 | 3.5E+15 | 100 | 100 |
| C3 | —/—/— | 104 | Non SS | 100 | 6.7E+15 | N/A | N/A |
| C4 | —/—/— | 104 | Non SS. | >400 | N/A | N/A | N/A |
| C5 | —/—/— | 69 | SS | 240 | 2.6E+16 | N/A | N/A |
| C6 | —/—/— | 104 | Non SS. | 120 | 1.7E+15 | N/A | N/A |

^{[1]}Average value for the entire time of a test.
^{[2]}Average value for the first 2,000 hours if a test lasts longer than 2,000 hours; average value for the entire time of the test if it lasts shorter than 2,000 hours.
#N/A means not applicable because it was not measured or calculated.
*Example 3 was first operated at sub-saturated outlet conditions (50/0% inlet RH) for 2,300 hours, and then switched to a non sub-saturated condition (50/50% inlet RH) until membrane failure.
**In cases where “>” is shown, test was ended before membrane failure, so lifetime is at least the value shown.
^{‡}Test was terminated because of cell gasket failure. At the time of termination the membrane had not failed.

1. A method of operating a fuel cell at an operating temperature below about 150 degrees Celsius, said fuel cell having an anode and a cathode with an electrolyte interposed therebetween, said cathode having at least one surface in contact with a cathode chamber having a gas inlet and a gas outlet, and said anode in contact with an anode chamber having a gas inlet and a gas outlet, and said electrolyte containing less than about 500 ppm of a catalyst capable of enhancing the formation of radicals from hydrogen peroxide, said method comprising the steps of:
i. Applying a fuel to said anode chamber;
ii. Applying an oxidant to said cathode chamber;
iii. Controlling the amount of water supplied to said anode chamber and said cathode chamber such that water vapor is sub-saturated at said operating temperature at the gas outlet of the cathode chamber.

2. The method of claim 1 wherein said fuel cell is a polymer electrolyte membrane fuel cell having an anode, a cathode, and an electrolyte interposed therebetween, wherein said electrolyte comprises a polymer.

3. The method of claim 2 wherein said polymer comprises a polymer containing ionic acid functional groups attached to the polymer backbone, wherein said ionic acid functional groups are selected from the group of sulfonic, sulfonimide and phosphonic acids; and optionally further comprises a fluoropolymer.

4. The method of claim 3 wherein said polymer is selected from the group containing perfluorosulfonic acid polymers, polystyrene sulfonic acid polymers, sulfonated poly(aryl ether ketones); and polymers comprising phthalazinone and a phenol group, and at least one sulfonated aromatic compound.

5. The method of claim 2 wherein said electrolyte comprises a composite membrane comprising:
i. An expanded polytetrafluoroethylene membrane having a porous microstructure of polymeric fibrils, and optionally nodes;
ii. An ion exchange material impregnated throughout the membrane, wherein the ion exchange material substantially impregnates the membrane to render an interior volume of the membrane substantially occlusive.

6. The method of claim 2 wherein the fuel comprises hydrogen and the oxidant comprises oxygen.

7. The method of claim 2 wherein the amount of water supplied to said anode chamber and said cathode chamber is such that the water vapor is sub-saturated at the anode inlet, and optionally, at the cathode inlet.

8. The method of claim 2 wherein the concentration of said catalyst capable of enhancing the formation of radicals from hydrogen peroxide in the membrane is less than about 150 ppm.

9. The method of claim 2 wherein wherein the concentration of said catalyst capable of enhancing the formation of radicals from hydrogen peroxide in the membrane is less than about 20 ppm.

10. The method of claim 2 wherein the operating temperature is between about 40 degrees Celsius and about 150 degrees Celsius.

11. The method of claim 10 wherein the operating temperature is about 130 degrees Celsius.

12. The method of claim 10 wherein the operating temperature is about 110 degrees Celsius.

13. The method of claim 10 wherein the operating temperature is about 95 degrees Celsius.

14. The method of claim 10 wherein the operating temperature is about 80 degrees Celsius.

15. A method of operating a fuel cell at an operating temperature below about 150 degrees Celsius, said fuel cell having an anode and a cathode with an electrolyte interposed therebetween, said anode having at least one surface in contact with an anode chamber having a gas inlet and a gas outlet, and said cathode in contact with a cathode chamber having a gas inlet and a gas outlet, and said electrolyte containing less than about 500 ppm of a catalyst capable of enhancing the formation of radicals from hydrogen peroxide, said method comprising the steps of:
i. Applying a fuel to said anode chamber;
ii. Applying an oxidant to said cathode chamber;
iii. Controlling the amount of water supplied to said anode chamber and said cathode chamber such that water vapor is sub-saturated at said operating temperature at the gas outlet of the anode chamber.

16. The method of claim 15 wherein said fuel cell is a polymer electrolyte membrane fuel cell having an anode, a cathode, and an electrolyte interposed therebetween, wherein said electrolyte comprises a polymer.

17. The method of claim 16 wherein said polymer comprises a polymer containing ionic acid functional groups attached to the polymer backbone, wherein said ionic acid functional groups are selected from the group of sulfonic, sulfonimide and phosphonic acids; and optionally further comprises a fluoropolymer.

18. The method of claim 17 wherein said polymer is selected from the group containing perfluorosulfonic acid polymers, polystyrene sulfonic acid polymers; sulfonated poly(aryl ether ketones); and polymers comprising phthalazinone and a phenol group, and at least one sulfonated aromatic compound.

19. The method of claim 16 wherein said electrolyte comprises a composite membrane comprising:
i. An expanded polytetrafluoroethylene membrane having a porous microstructure of polymeric fibrils, and optionally nodes;
ii. An ion exchange material impregnated throughout the membrane, wherein the ion exchange material substantially impregnates the membrane to render an interior volume of the membrane substantially occlusive.

20. The method of claim 16 wherein the fuel comprises hydrogen and wherein the oxidant comprises oxygen.

21. The method of claim 16 wherein the amount of water supplied to said anode chamber and said cathode chamber is such that the water vapor is sub-saturated at the anode inlet, and optionally, at the cathode inlet.

22. The method of claim 21 wherein the concentration of said catalyst capable of enhancing the formation of radicals from hydrogen peroxide in the membrane is less than about 150 ppm.

23. The method of claim 22 wherein wherein the concentration of said catalyst capable of enhancing the formation of radicals from hydrogen peroxide in the membrane is less than about 20 ppm.

24. The method of claim 16 wherein the operating temperature is between about 40 degrees Celsius and about 150 degrees Celsius.

25. The method of claim 24 wherein the operating temperature is about 130 degrees Celsius.

26. The method of claim 24 wherein the operating temperature is about 110 degrees Celsius.

27. The method of claim 24 wherein the operating temperature is about 95 degrees Celsius.

28. The method of claim 24 wherein the operating temperature is about 80 degrees Celsius.

29. A method of operating a fuel cell at an operating temperature below about 150 degrees Celsius, said fuel cell having an anode and a cathode with an electrolyte interposed therebetween, said anode having at least one surface in contact with an anode chamber, and said cathode in contact with a cathode chamber, and said electrolyte containing less than about 500 ppm of a catalyst capable of enhancing the formation of radicals from hydrogen peroxide, said method comprising the steps of:
i. Applying a fuel to said anode chamber;
ii. Applying an oxidant to said cathode chamber;
iii. Controlling the amount of water supplied to said anode chamber and said cathode chamber such that the average water vapor in said fuel cell is sub-saturated at said operating temperature.

30. The method of claim 29 wherein said fuel cell is a polymer electrolyte membrane fuel cell having an anode, a cathode, and an electrolyte interposed therebetween, wherein said electrolyte comprises a polymer.

31. The method of claim 30 wherein said polymer comprises a polymer containing ionic acid functional groups attached to the polymer backbone, wherein said ionic acid functional groups are selected from the group of sulfonic, sulfonimide and phosphonic acids; and optionally further comprises a fluoropolymer.

32. The method of claim 30 wherein said polymer is selected from the group containing perfluorosulfonic acid polymers, polystyrene sulfonic acid polymers; sulfonated poly(aryl ether ketones); and polymers comprising phthalazinone and a phenol group, and at least one sulfonated aromatic compound.

33. The method of claim 29 wherein said electrolyte comprises a composite membrane comprising:
i. An expanded polytetrafluoroethylene membrane having a porous microstructure of polymeric fibrils, and optionally nodes;
ii. An ion exchange material impregnated throughout the membrane, wherein the ion exchange material substantially impregnates the membrane to render an interior volume of the membrane substantially occlusive.

34. The method of claim 30 wherein the fuel comprises hydrogen and said oxidant comprises oxygen.

35. The method of claim 30 wherein the concentration of said catalyst capable of enhancing the formation of radicals from hydrogen peroxide in the membrane is less than about 150 ppm.

36. The method of claim 30 wherein wherein the concentration of said catalyst capable of enhancing the formation of radicals from hydrogen peroxide in the membrane is less than about 20 ppm.

37. The method of claim 30 wherein the operating temperature is between about 40 degrees Celsius and about 150 degrees Celsius.

38. The method of claim 38 wherein the operating temperature is about 130 degrees Celsius.

39. The method of claim 38 wherein the operating temperature is about 110 degrees Celsius.

40. The method of claim 38 wherein the operating temperature is about 95 degrees Celsius.

41. The method of claim 38 wherein the operating temperature is about 80 degrees Celsius.

42. An apparatus for operating a fuel cell comprising sensors to measure the outlet relative humidity of the gas outlets of a fuel cell and a means to control the relative humidity on the gas inlets of a fuel cell, such that said apparatus can control the relative humidity of the gas inlets to maintain sub-saturated conditions of the fuel cell on the anode outlet.

43. An apparatus for operating a fuel cell comprising sensors to measure the outlet relative humidity of the gas outlets of a fuel cell and a means to control the relative humidity on the gas inlets of a fuel cell, such that said apparatus can control the relative humidity of the gas inlets to maintain sub-saturated conditions of the fuel cell on the cathode outlet.

44. An apparatus for operating a fuel cell comprising sensors to measure outlet relative humidity of the gas outlets of a fuel cell and a means to control the relative humidity on the gas inlets of a fuel cell, such that said apparatus can control the relative humidity of the gas inlets to maintain an average relative humidity in the fuel cell of less than 100%.
